(19) United States
(12) Patent Application Publication
(10) Pub. No.: US 2013/0100673 A1
(43) Pub. Date: Apr. 25, 2013

(54) STREET LUMINAIRE

(71) Applicants: Waldemar Kurkofka, Rheda-Wiedenbruck (DE); Hendrik Kleinemeier, Rietberg (DE); Alexander Kerpe, Lippstadt (DE)

(72) Inventors: Waldemar Kurkofka, Rheda-Wiedenbruck (DE); Hendrik Kleinemeier, Rietberg (DE); Alexander Kerpe, Lippstadt (DE)

(21) Appl. No.: 13/633,634

(22) Filed: Oct. 2, 2012

Related U.S. Application Data
(63) Continuation of application No. PCT/EP2011/054916, filed on Mar. 30, 2011.

(30) Foreign Application Priority Data
Apr. 3, 2010 (DE) 102010013801.0

(51) Int. Cl. F21V 31/00

(52) U.S. Cl. CPC F21V 31/00
USPC 362/249.06; 362/249.14

(57) ABSTRACT

The invention relates to a street lamp. In order to reduce the sealing expenditure, it is proposed to arrange the ballast device in the lamp head. A lead is here designed in one piece from a terminal box to the holders.

The invention relates to a street lamp comprising a pole in the base region whereof a junction box is arranged, comprising a lamp head in which at least one illuminant is arranged, comprising at least one ballast device and comprising an electrical lead which is guided in one piece from the junction box to the lamp head.

Such street lamps are known per se and are used for lighting of, for example, roads and pathways. The lamp head is either fastened directly or by means of a side arm at the upper end of the pole.

Known from US 2009/0046449 A1 is a street lamp in which a lamp head with LED lights is arranged on a side arm of a pole. An electrical lead of the street lamp is connected electrically in a junction box to a power supply network. The lead is guided in the lamp head. A ballast device is arranged in the junction box. This has the disadvantage that the ballast device and its terminals must be sealed against wetness and moisture.

It is therefore the object of the invention to provide a street lamp in which a sealing expenditure is reduced.

The object is solved by the features of claim 1. The ballast device is arranged in the lamp head. As a result, said ballast device can be integrated in the street lamp in a watertight manner without additional expenditure and protected from moisture.

The subclaims relate to the advantageous embodiment of the invention.

In one alternative the illuminant is at least one LED array. This has a low energy requirement with a high light yield. Further components, e.g. for energy management can be simply arranged on a printed circuit board of the LED array.

In a preferred alternative the LED array is combined with the ballast device to form a watertight module. As a result, the entire electrics/electronics are securely encapsulated. During maintenance and in the case of a fault, only a few parts need to be examined and optionally repaired or exchanged. Overall the assembly expenditure of the street lamp is reduced.

In a further alternative, the module is contacted by means of a plug as holder in a watertight manner with the lead. This facilitates assembly and maintenance work. The module can be safely exchanged when voltage is applied so that immediate monitoring is possible.

The invention is explained in detail hereinafter with reference to the appended drawings. In the figures:

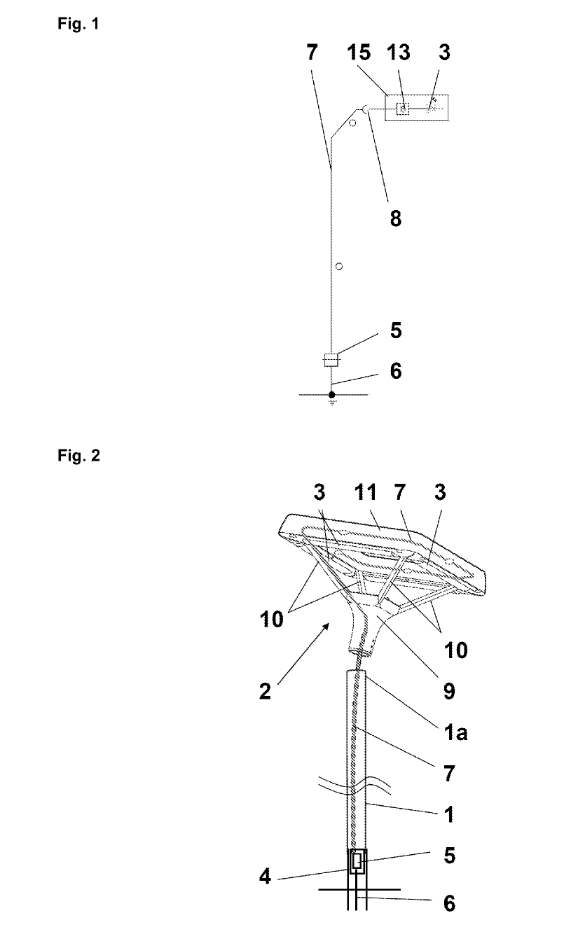

FIG. 1 shows an electrical diagram of a street lamp,

FIG. 2 shows a schematic diagram of the street lamp,

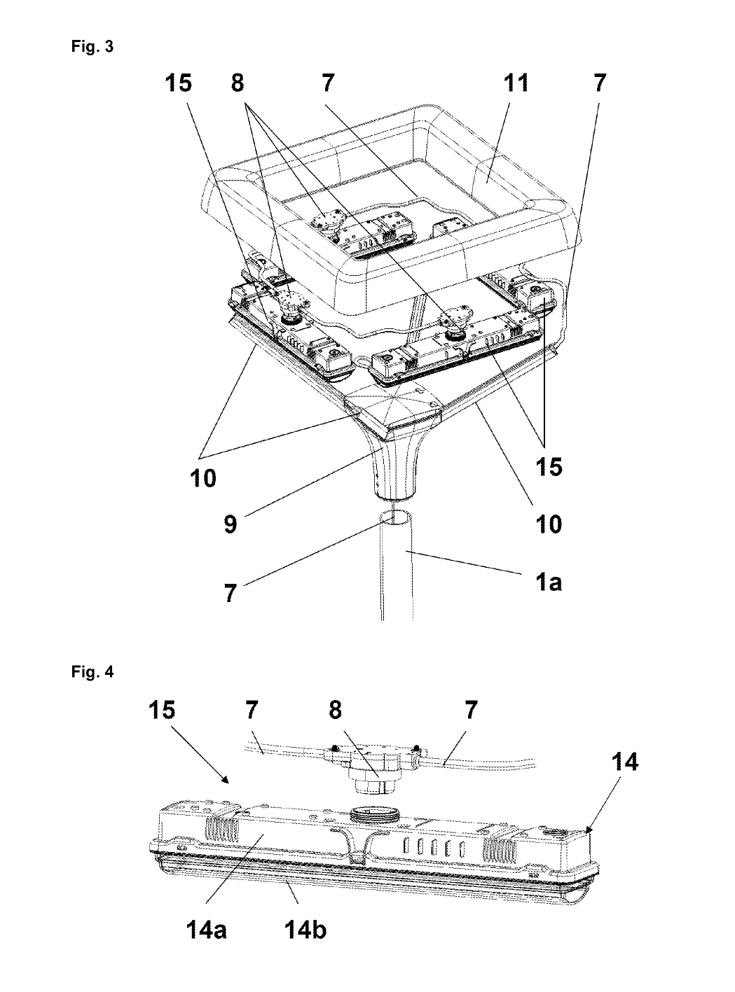

FIG. 3 shows an exploded view of a pole top with a lamp head and

FIG. 4 shows a view of the illuminant module and a cable section with plug as detail and

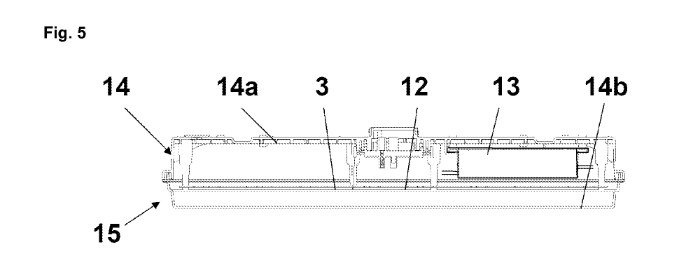

FIG. 5 shows a section through the module.

As can be seen from the figures, a first end of the pole 1 of a street lamp is, for example, anchored in the ground. A lamp head 2 is fastened to an upper second end of the pole 1, a pole top 1a. Illuminants 3 are arranged in the lamp head 2 so that during operation they emit light downwards in the direction of the bottom with a defined light distribution.

In its lower region the pole 1 has a junction box 4 at a height of about 0.5 m to 1.0 m above the ground. The junction box 4 comprises a terminal box 5 which is fastened in the pole 1 and at which a cable connection 6 can be connected to an electrical power supply network. An electrical lead 7 (cable) is connected to the terminal box 5, which lead is guided in one piece in the pole 1 and further to holders for the illuminants 3. The junction box 4 can be closed by means of a door not shown. For connection of the illuminants 3 to the lead 7, the holders in the form of plugs 8 are contacted in parallel according to the number of illuminants 3 and fastened in a watertight manner. The lead 7 is looped through into the plugs 8.

The lamp head 2 comprises a base 9 which is fastened by its lower end to the pole top 1a. At an upper end of the base 9, four tubular struts 10 are fastened with equal spacing, which struts point obliquely radially outwards and upwards in a radial manner. An annular hood 11 is fastened at upper ends of the struts 10. The hood 11 is fundamentally rectangular with rounded corners and an approximately U-shaped cross-section which is open towards the bottom. The lead 7 is guided through the base 9 and one of the struts 10 into the hood 11.

The four illuminants 3 here are fastened detachably inside the cross-section of the hood 11. Each of the illuminants 3 comprises an LED array 12 having a plurality of LEDs which are arranged on a printed circuit board together with other electrical and/or electronic components. Each illuminant 3 is assigned a ballast device 13. The illuminant 3 and the ballast device 13 are combined in a housing 14 to form a module 15. The housing 14 comprises a box-shaped receptacle 14a in which a socket for one of the plugs 8 is integrated and a cover 14b made of transparent clear material. The LEDs are directed towards the cover 14b. The receptacle 14a and the cover 14b are glued tightly to one another.

Alternatively to the LED array 12, other illuminants such as, for example, incandescent lamps or fluorescent lamps can be used.

### REFERENCE LIST

1 Pole
1a Pole top
2 Lamp head
3 Illuminant
4 Junction box
5 Terminal box
6 Cable connection
7 Lead
8 Plug
9 Base
10 Strut
11 Hood
12 LED array
13 Ballast device
14 Housing
14a Receptacle
14b Cover
15 Module

1. Street lamp comprising a pole in the base region whereof a junction box is arranged, comprising a lamp head in which at least one illuminant is arranged, comprising at least one ballast device and comprising an electrical lead which is guided in one piece from the junction box to the lamp head, characterized in that the ballast device is arranged in the lamp head.

2. The street lamp according to claim 1, characterized in that the illuminant is at least one LED array.

3. The street lamp according to claim 2, characterized in that the LED array is combined with the ballast device to form a watertight module.

4. The street lamp according to claim 1, characterized in that the illuminant is contacted by means of a plug as holder in a watertight manner with the lead.
